(19) United States
(12) Patent Application Publication
(10) Pub. No.: US 2006/0254270 A1
(43) Pub. Date: Nov. 16, 2006

(54) Resonance frequency adjusting method and stirling engine

(76) Inventor: Shohzoh Tanaka, Nara (JP)

Correspondence Address: BIRCH STEWART KOLASCH & BIRCH, PO BOX 747, FALLS CHURCH, VA, 22040-0747, US

(21) Appl. No.: 10/551,249

(22) PCT Filed: Apr. 10, 2003
(86) PCT No.: PCT/JP04/05048

§ 371 Date: Sep. 28, 2005

(30) Foreign Application Priority Data
Apr. 10, 2003 (JP) 2003-106178

(51) Int. Cl. F02G 1/04; F01B 29/10

(52) U.S. Cl. 60/517

(57) ABSTRACT

With spacers (30, 31) held between the central portion and the circumference of two plate springs (61, 61), a fixed shaft (67) erected on a fixed block (70) is inserted in a through hole (64) in the periphery of the plate spring (61) and also in the spacer (31), and nuts (68, 68) are applied for tightening from above and below (step #1). Thereby, a displacer supporting spring (6) is fixed to the fixed block (70). And the threaded portion (2b) of a rod (2a) is inserted in a through hole (63) in the center of the plate spring (61) and also in the spacer (30) from the upper surface side of the upper plate spring (61), and a nut (32) is attached to the threaded portion (2b) projecting from the lower surface of the lower plate spring (61) so as to fix the displacer (2) to the upper surface side of the upper plate spring (61) (step #2). In this state, small vibration is applied to the displacer supporting spring (6) (step #3). And the resonance frequency is detected (step #4) and on the basis of this result, the spring constant of the displacer support spring (6) (the combined spring constant of the two plate springs (61, 61)) is calculated, and then an additional weight ΔWd reaching the target resonance frequency is calculated (step #5).

### TECHNICAL FIELD

The present invention relates to a resonance frequency adjusting method for use in a vibration system of a movable body elastically supported with a plate spring, and to a Stirling engine whose resonance frequency is adjusted according to the method.

### BACKGROUND ART

Conventionally, Stirling engines exploiting a reversed Stirling cycle vibrate a piston by using a driving mechanism such as a linear motor so as to make a displacer supported with a plate spring resonate therewith (for example, see Japanese Patent Application Laid-Open No. H5-288419 (pp. 3-5 and FIGS. 1 and 2) and Japanese Patent Application Laid-Open No. H10-325629 (pp. 5-6 and FIGS. 1 and 2)). When the plate spring has a certain spring constant, one vibration system is established that vibrates at a resonance frequency that is substantially equal to the vibration cycle of the linear motor. This makes the displacer reciprocate via the plate spring.

In general, when a movable body that has a mass of m and is elastically supported with a spring having a spring constant k resonates, the resonance frequency f of the vibration system thereof is expressed as:
f=(½π)\sqrt{k/m} (1)

However, displacers are not always manufactured with exactly constant processing accuracy, producing differences between the weights of the manufactured displacers. The problem here is that even a slight error of about 0.1 gram can make a deviation in resonance frequency.

In view of the conventionally experienced inconveniences and disadvantages described above, it is an object of the present invention to provide a method by which a resonance frequency can be adjusted to a target value by correcting differences among the weights of individual displacers by the use of a simple scheme and inexpensive components.

### DISCLOSURE OF THE INVENTION

To achieve the above object, according to the present invention, in a method for adjusting the resonance frequency of a vibration system having a movable body fixed to a plate spring, an additional weight that achieves a target resonance frequency is calculated in advance, and a weight corresponding to the calculated additional weight is added to the vibration system.

With this method, in the vibration system as a whole, the movable body is made to reciprocate with a weight equal to the sum of its own weight and the calculated additional weight.

Advisably, the procedure for calculating the additional weight includes the steps of: fixing the movable body or a weight corresponding to the weight of the movable body to a plate spring; applying slight vibration to the plate spring; detecting the resonance frequency of the vibration; and calculating, based on the detected resonance frequency, an additional weight that achieves the target resonance frequency.

The resonance frequency adjusting method described above can be applied to a Stirling engine provided with: a cylinder; a piston and a displacer that reciprocate in the direction of an axis of the cylinder; a displacer supporting spring elastically supporting the displacer; and a bolt that fixes the displacer at the center of the displacer supporting spring. With this method, the displacer is fixed to the displacer supporting spring along with a washer having the weight corresponding to the calculated additional weight that achieves the target resonance frequency. This makes it possible to adjust the resonance frequency of the displacer vibration system to a target value.

### BRIEF DESCRIPTION OF DRAWINGS

FIG. 1 is a sectional view showing an example of a free-piston Stirling refrigerating unit embodying the invention;

FIG. 2A is a plan view showing an example of a plate spring constituting a piston supporting spring;

FIG. 2B is a side sectional view of the plate spring;

FIG. 3A is a plan view showing an example of a plate spring constituting a displacer supporting spring;

FIG. 3B is a side sectional view of the plate spring;

FIG. 4 is a partially exploded sectional view showing the procedure for mounting a displacer supporting spring and a displacer supporting spring on a Stirling refrigerating unit;

FIG. 5 is a schematic side sectional view showing the procedure for adjusting the resonance frequency of a displacer vibration system; and

FIG. 6 is a flow chart of the adjustment procedure.

### BEST MODE FOR CARRYING OUT THE INVENTION

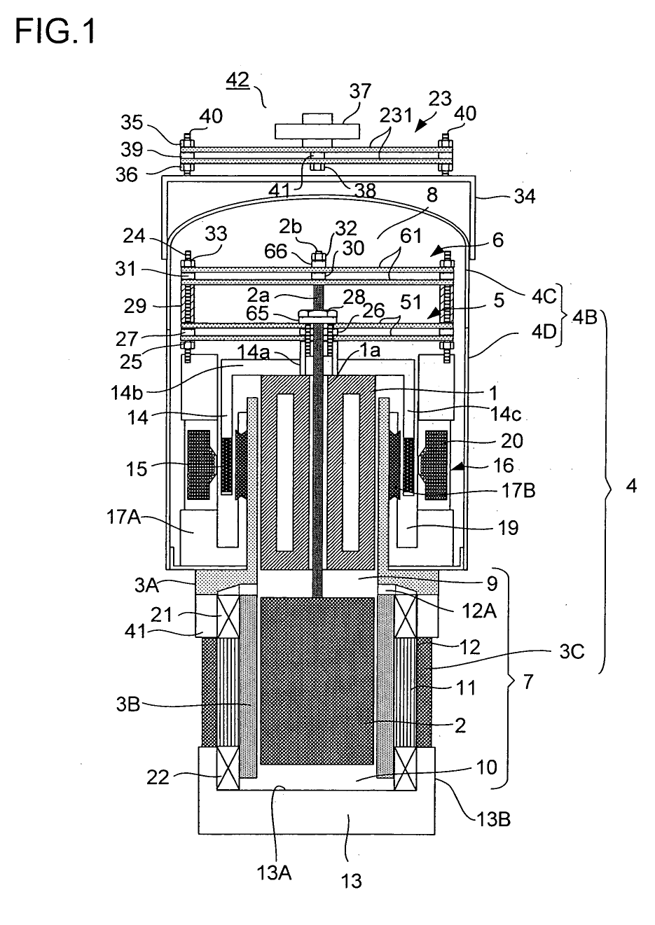

An example of how the present invention is carried out will be described below with reference to the accompanying drawings. FIG. 1 is a sectional view showing an example of a free-piston Stirling refrigerating unit. This Stirling refrigerating unit has various components housed inside a pressure-resistant container 4 for the purpose of running a Stirling cycle to achieve cooling at a cold head 13.

The individual components will be described below. The pressure-resistant container 4 is mainly composed of a vessel 4B disposed on a rear space 8 side and an outer casing 3C disposed on a work space 7 side. The vessel 4B is further divided into two structures. Of these two structures, one is a vessel main body 4D located on a cold head 13 side, and the other is a vessel cap 4C located on the side opposite to the cold head 13 (which side, in this specification, is referred to as a vibration isolator side. Note that, in the description of the unit construction, even when a vibration isolator 42 is not yet mounted, for convenience' sake, the term “vibration insulator side” is used as if the unit were already finished).

Inside the pressure-resistant container 4, cylinders 3A and 3B connected together are disposed with a communication hole 12A left therebetween. A piston 1 and a displacer 2 that can reciprocate on the same axis as the cylinders 3A and 3B are inserted into the cylinders 3A and 3B, respectively. Furthermore, a linear motor 16 that drives the piston 1 is provided on the outer side of the cylinder 3A.

The space inside the pressure-resistant container 4 is roughly divided into two spaces. Of these two spaces, one is a rear space 8 surrounded mainly by the vessel 4B and the piston 1, and the other is a work space 7 surrounded mainly by the piston 1, the outer casing 3C, and the cold head 13. The work space 7 is further divided by the displacer 2 into two spaces. Of these two spaces, one is a compression space 9 lying between the displacer 2 and the piston 1, and the other is an expansion space 10 lying between the displacer 2 and the cold head 13.

The compression space 9 and the expansion space 10 communicate with each other via a communication passageway 12 formed between the cylinder 3B and the outer casing 3C. A higher-temperature-side internal heat exchanger 21, a regenerator 11, and a lower-temperature-side internal heat exchanger 22 are disposed inside the communication passageway 12 in the order mentioned from the compression space 9 toward the expansion space 10.

The cold head 13 is made of a material having high thermal conductivity such as copper or aluminum and has substantially the shape of a bottomed cylinder. The cold head 13 is so disposed that a bottom portion 13A thereof faces the opening of the cylinder 3B and an edge portion 13B thereof faces the lower-temperature-side internal heat exchanger 22. On the other hand, a warm head 41 is made of a material having high thermal conductivity such as copper or aluminum and has the shape of a ring. The warm head 41 is so disposed that the inner circumference thereof faces the outer circumference of the higher-temperature-side internal heat exchanger 21.

The piston 1 is a cylindrical structure having, along the center axis thereof, a bore 1a through which a rod 2a can be placed. Furthermore, the piston 1 is provided with a gas bearing (not shown) that releases the refrigerant compressed by the compression space 9 into a clearance between the outer circumferential surface of the piston 1 and the cylinder 3A to exert a bearing effect.

The displacer 2 is a cylindrical structure, and is provided with a gas bearing (not shown) that releases the refrigerant compressed by the compression space 9 into a clearance between the outer circumferential surface of the displacer 2 and the cylinder 3B to exert a bearing effect. The rod 2a is fixed to the piston 1-side surface of the displacer 2, and is placed through the bore 1a of the piston 1. The rod 2a has a screw portion 2b formed at the end thereof opposite to the displacer 2.

The linear motor 16 is mainly composed of permanent magnets 15 arranged in a ring, a sleeve 14 that holds the permanent magnets 15, an outer yoke 17A, and an inner yoke 17B. The outer yoke 17A has a number of substantially C-shaped flat iron core plates fixed together in the form of a ring, and has, placed inside it, a coil 20 wound around a bobbin, with all these sandwiched between non-magnetic members from axially opposite sides. The inner yoke 17B has a number of flat iron core plates fixed together in the form of a ring. A clearance 19 is formed between the inner circumference of the outer yoke 17A and the outer circumference of the inner yoke 17B. The permanent magnets 15 held by the sleeve 14 are disposed in the clearance 19.

The sleeve 14 has the shape of a bottomed cylinder, and has a ring-shaped trench at the edge of a wall portion 14c in the inner circumference thereof. A plurality of arc-shaped permanent magnets 15 are disposed in the trench so as to form a ring-shaped permanent magnet as a whole. The sleeve 14 has, at the center of a bottom portion 14b thereof, a bore through which the rod 2a can be placed. The bore has a boss portion 14a so formed as to protrude from the inner wall of the bore toward the side opposite to the side where the wall portion 14c is formed and to have the threaded inner circumferential surface. The piston 1 is adjusted so that the axis thereof and the center of the bottom portion 14b are arranged on the same axis, and is fixed to the wall portion 14c-side surface of the bottom portion 14b with a fixing means such as a bolt.

On the vibration isolator-side end surface of the outer yoke 17A, three or more (e.g., four) fixing axes 24 for fixing a piston supporting spring 5 and a displacer supporting spring 6, which will be described below, are vertically provided toward the vibration isolator side. Note that used as the fixing axes 24 described above are those having a threaded outer circumference.

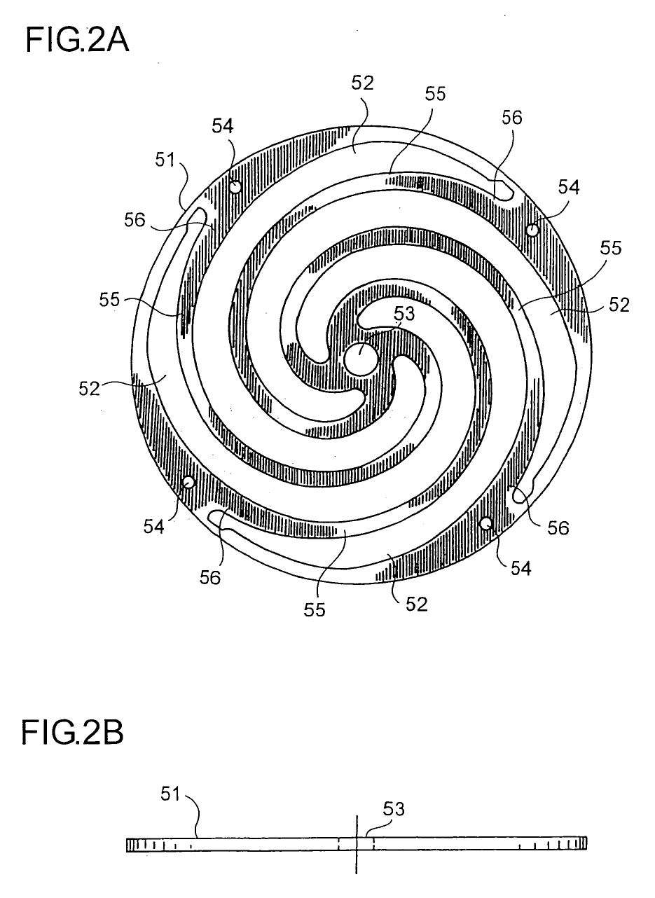

The piston supporting spring 5 is formed as shown in FIG. 2. FIG. 2A is a plan view showing an example of a plate spring 51 constituting the piston supporting spring 5, and FIG. 2B is a side sectional view of the plate spring 51. The plate spring 51 is formed as follows. A stainless steel circular plate having a predetermined diameter and thickness is used as a base, and four spiral slits 52 that are equiangularly spaced are provided therein. Furthermore, a bore 53 through which the rod 2a and a bored bolt 28 are placed are provided at the center of the circular plate. Still further, the circular plate has provided therein as many bores 54 through which as there are placed fixing axes 24 are placed, with each bore located on the extension line from the outer circumference-side end portion of a slit 52. Cutting the circular plate out of a flat plate and forming the slits 52 and the bores 53 and 54 are performed, for example, by laser processing.

As a result of the processing described above, arm portions 55 are formed between the slits 52 as spiral portions disposed equiangularly about the center of the circular plate. These arm portions 55 gives the circular plate a predetermined elastic modulus in the direction perpendicular to the plate surface of the circular plate, namely in the axial direction.

Note that the shapes shown in FIGS. 2A and 2B are for illustration only. Since the range of the spring constant of the plate spring 51 is determined to a certain extent by the diameter and thickness of the circular plate, it is possible to set the spring constant to a predetermined value within the above range in accordance with the shape of the slit 52 and the number of recurring patterns thereof.

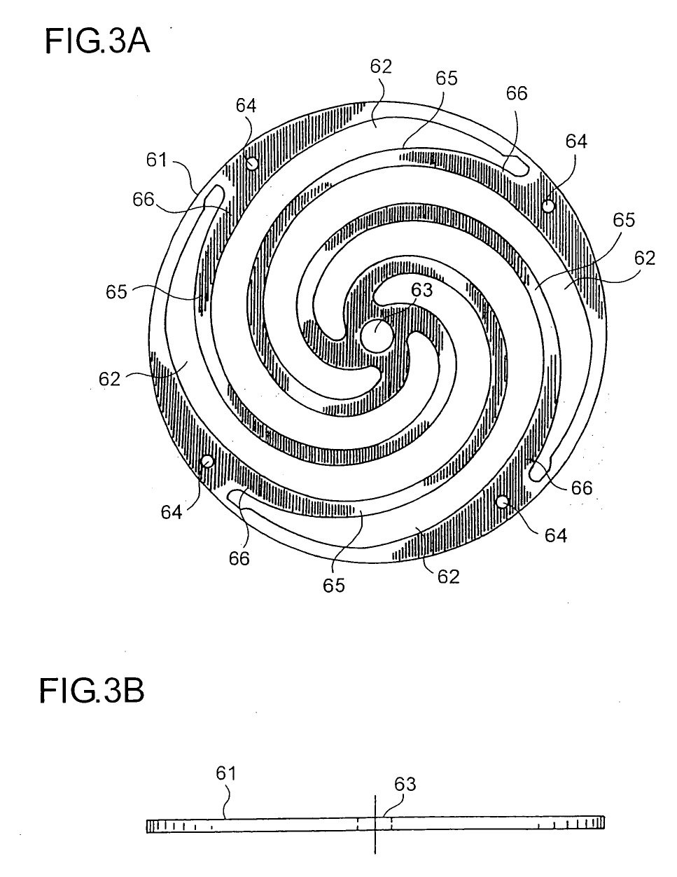

The displacer supporting spring 6 is formed as shown in FIGS. 3A and 3B. Since the displacer supporting spring 6 is approximately the same shape as the piston supporting spring 5, redundant explanations thereof will be omitted. The only difference is the size of the bore provided at the center. Specifically, the bore 63 formed at the center of the displacer supporting spring 6 is made smaller than the bore 53 of the piston supporting spring 5, because it only needs to be put around the screw portion 2b of the rod 2a and not around the bored bolt 28.

The displacer 2 and the displacer supporting spring 6 constitute a vibration system, and the resonance frequency thereof is given by formula (1) noted above. However, considering the processing accuracy of the production procedure of the displacer 2, differences inevitably arise between the weights of individual displacers. This often results in displacers having weights outside the rated weight range. Moreover, due to variations in the processing accuracy of plate springs, it is impossible to mass-produce plate springs having a strictly constant spring constant. To make matters worse, these differences occur spontaneously. This inconveniently makes it necessary to carry an inventory large enough to permit one to find out a combination of the displacer 2 and the plate spring 61 that gives a fixed value as the k/m ratio in formula (1).

Therefore, to absorb differences between the weights of displacers 2 and differences between the spring constants of plate springs 61, the resonance frequency of the vibration system is adjusted as follows before those components are built in Stirling refrigerating units.

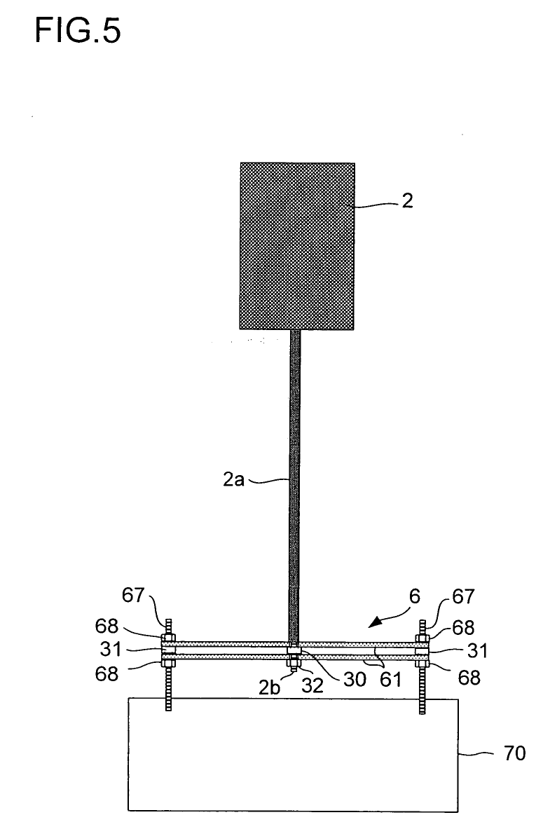

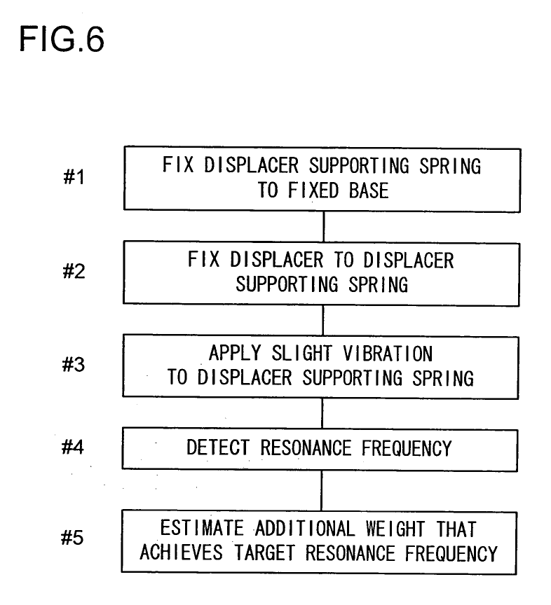

FIG. 5 is a schematic side sectional view showing the procedure for adjusting the resonance frequency of the vibration system of the displacer, and FIG. 6 is a flowchart of the adjustment procedure. First, spacers 30 and 31 are sandwiched between the two plate springs 61, with the spacer 30 located at the center and the spacers 31 located at the edge. Then, the bores 64 formed at the edge of the plate springs 61 and the spacers 31 are put around the fixing axes 67 held upright on the fixed base 70. Finally, the plate springs 61 are locked with nuts 68 from above and from below (step #1). In this way, the displacer supporting spring 6 is fixed to the fixed base 70.

Then, the screw portion 2b of the rod 2a is placed through the bores 63 formed at the centers of the plate springs 61 and through the spacer 30 from the top surface side of the upper plate spring 61, and the end of the screw portion 2b that then appears at the bottom surface of the lower plate spring 61 is locked with a nut 32. In this way, the displacer 2 is fixed to the top surface side of the upper plate spring 61 (step #2). In this state, slight vibration is applied to the displacer supporting spring 6 (step #3).

Then, the resonance frequency is detected (step #4). Based on the detection result, the spring constant of the displacer supporting spring 6 (the combined spring constant of the two plate springs 61) is calculated, and then the additional weight ΔWd that achieves the target resonance frequency is calculated (step #5).

Likewise, the resonance frequency adjustment procedure is also performed for the vibration system of the piston 1, and the additional weight ΔWp that achieves the target resonance frequency is calculated.

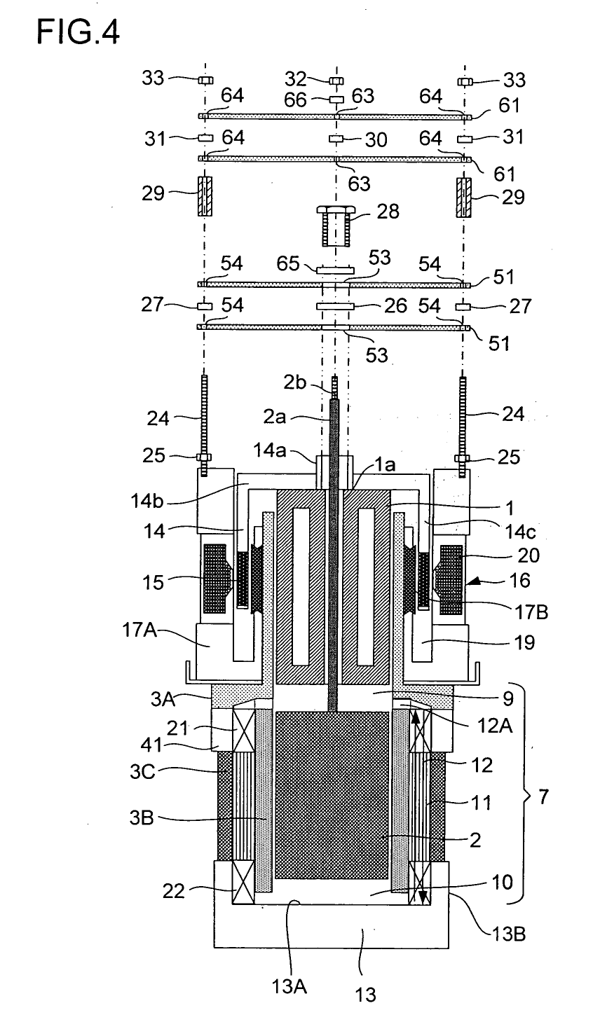

How the piston supporting spring 5 and the displacer supporting spring 6 are mounted will be described below with reference to FIG. 4. FIG. 4 is a partially exploded sectional view showing the procedure for mounting the piston supporting spring 5 and the displacer supporting spring 6 on the Stirling refrigerating unit.

First, the fixing axis 24 is fitted with a nut 25 that serves as a spacer to prevent the piston supporting spring 5 from coming into contact with the vibration isolator-side end surface of the outer yoke 17A. Then, the bores 54 formed in one of the two plate springs 51 constituting the piston supporting spring 5 are put around the fixing axes 24, and the bore 53 is put around the rod 2a from the vibration isolator-side end thereof, so that it is placed on the vibration isolator-side end surface of the boss portion 14a. Then, a spacer 26 (e.g., a washer) having a bore whose diameter is greater than the outer circumference of the bored bolt 28 and having a thickness of about 1 mm is put around the rod 2a from the vibration isolator-side end thereof, so that it is disposed on the same axis as the rod 2a. Furthermore, spacers 27 (e.g., washers) each having a bore whose diameter is greater than the outer circumference of the fixing axis 24 and having the same thickness as the spacer 26 are put around the fixing axes 24.

Then, the second plate spring 51 is disposed in the same manner as the first plate spring 51 and coaxially therewith on the vibration isolator side of the spacer 27. Then, a washer 65 that corresponds to the additional weight ΔWp calculated by the above-mentioned procedure for adjusting the resonance frequency of the vibration system is put around the rod 2a from the vibration isolator-side end thereof, so that it is disposed on the same axis as the rod 2a. Then, the bored bolt 28 is put around the rod 2a from the vibration isolator-side end thereof with the washer 65 sandwiched between the bored bolt 28 and the plate spring 51, and the threaded portion thereof is screwed into the boss portion 14a formed at the center of the sleeve 14. In this way, the piston supporting spring 5 is fixed in position.

As described above, in the vibration system of the piston 1 assembled with the washer 65 placed in between, the weight of the washer 65 is added to where the movable body (including the piston 1, the sleeve 14, the bored bolt 28, and the spacers 26 and 27, etc.) is fixed. As a result, the movable body as a whole has the weight of the piston 1 plus the calculated additional weight ΔWp. This makes it possible to easily obtain the vibration system of the piston 1 whose resonance frequency is adjusted to the target resonance frequency by the use of a simple scheme and inexpensive components. Moreover, in the example described above, the piston 1 included in the movable body and the additional weight are coaxially fixed with the bored bolt 28. This helps keep a balance in the circumferential direction. Furthermore, the additional weight is fixed in position while being put around the rod 2a. Thus, even when the piston 1 vibrates vigorously, the additional weight does not come off.

Instead of using the washer 65, the bored bolt 28 having the calculated additional weight ΔWp added to its own weight may be used for fixing the piston supporting spring 5.

Next, spacers 29 having a predetermined height are respectively put around the fixing axes 24 so that the lower ends thereof come into contact with the vibration isolator-side surface of the second plate spring 51 mounted on the side where the vibration isolator 42 is disposed. The height of the spacer 29 is determined in consideration of the amplitude of the piston 1. Specifically, the spacer 29 is so designed that the piston supporting spring 5 and the displacer supporting spring 6 do not come into contact with each other.

Following the spacers 29, the displacer supporting spring 6 is mounted. Specifically, the fixing axes 24 are placed through the bores 64 formed in one of the two plate springs 61 constituting the displacer supporting spring 6, and in addition the screw portion 2b of the rod 2a is placed through the bore 63. At this time, the cold head 13-side end portion of the displacer supporting spring 6 comes into contact with the shoulder between the rod 2a and the screw portion 2b. Then, a spacer 30 (e.g., a washer) having a bore whose diameter is greater than the outer circumference of the screw portion 2b and having a thickness of about 1 mm is put around the screw portion 2b. Furthermore, spacers 31 (e.g., washers) each having a bore whose diameter is greater than the outer circumference of the fixing axis 24 and having the same thickness of the spacer 30 are put around the fixing axes 24.

Then, as with the first plate spring 61, the second plate spring 61 is put around the screw portion 2b and the fixing axes 24. Then, the nut 32 and a washer 66 that corresponds to the additional weight ΔWd calculated by the above-mentioned procedure for adjusting the resonance frequency of the vibration system are put around the screw portion 2b. Furthermore, nuts 33 are put around the fixing axes 24. In this way, the displacer supporting spring 6 is fixed in position. At this time, the piston supporting spring 5 yields the combined spring constant of the two plate springs 51. Similarly, the displacer supporting spring 6 yields the combined spring constant of the two plate springs 61.

As described above, in the vibration system of the displacer 2 assembled with the washer 66 placed in between, the weight of the washer 66 is added to where the movable body (including the displacer 2, the rod 2a, the nut 32, and the spacers 30 and 31, etc.) is fixed. As a result, the movable body as a whole has the weight of the displacer 2 plus the calculated additional weight AD. This makes it possible to easily obtain the vibration system of the displacer 2 whose resonance frequency is adjusted to the target resonance frequency by the use of a simple scheme and inexpensive components. Moreover, in the example described above, the displacer 2 included in the movable body and the additional weight are coaxially fixed with the screw portion 2b. This helps keep a balance in the circumferential direction. Furthermore, the additional weight is fixed in position while being put around the screw portion 2b. Thus, even when the displacer 2 vibrates vigorously, the additional weight does not come off.

Instead of using the washer 66, the nut 32 having the calculated additional weight AD added to its own weight may be used for fixing the displacer supporting spring 6.

Incidentally, as shown in FIG. 1, the vibration isolator 42 for isolating vibration from the unit is disposed at the end of the pressure-resistant container 4 on the side thereof opposite to the cold head 13 in the axial direction. The vibration isolator 42 is mainly composed of a mass member supporting spring 23 and a mass member 37. The vibration isolator 42 is so designed that the resonance frequency calculated from the spring constant of a plate spring 231 and the weight of the system is made equal to the resonance frequency of the vibration system of the piston 1 and the vibration system of the displacer 2. With this construction, when vibration is produced by the piston 1 as it moves, the vibration isolator 42 resonates with the vibration, converting vibration energy into thermal energy. This makes it possible to reduce the vibration energy transmitted as a whole from the Stirling refrigerating unit and the vibration isolator 42 to the outside. Thus, it is possible to apply the resonance frequency adjusting method of the invention to the plate spring 231 of the vibration isolator 42.

### INDUSTRIAL APPLICABILITY

As described above, according to the present invention, an additional weight that achieves a target resonance frequency is calculated in advance by a procedure for adjusting the resonance frequency of a vibration system of a movable body, and the movable body is fixed to a plate spring along with a washer having the weight corresponding to the calculated additional weight. Thus, in the vibration system as a whole, the movable body is made to reciprocate with a weight equal to the sum of its own weight and the calculated addition weight. This makes it possible to realize the vibration system whose resonance frequency is adjusted to the target resonance frequency by the use of a simple scheme and inexpensive components.

1. (canceled)

2. (canceled)

3. A Stirling engine comprising:
a cylinder;
a piston and a displacer that reciprocate in a direction of an axis of the cylinder; and
a displacer supporting spring elastically supporting the displacer,
wherein the displacer is fixed at a center of the displacer supporting spring, and
wherein the displacer is fixed to the displacer supporting spring along with a washer having a weight corresponding to a calculated additional weight that achieves a target resonance frequency.
